(19) United States
(12) Patent Application Publication
(10) Pub. No.: US 2018/0093909 A1
(43) Pub. Date: Apr. 5, 2018

(54) ANAEROBIC DIGESTER ENHANCEMENT

(71) Applicant: Premier Magnesia, LLC, Wayne, PA (US)

(72) Inventor: Matthew P. Madolora, Austin, TX (US)

(21) Appl. No.: 15/724,611

(22) Filed: Oct. 4, 2017

Related U.S. Application Data
(60) Provisional application No. 62/403,926, filed on Oct. 4, 2016.

(51) Int. Cl. C02F 3/28; C02F 3/00; C02F 11/04

(52) U.S. Cl. CPC C02F 3/28; C02F 11/04; C02F 3/006

(57) ABSTRACT

Methods and systems for enhancing anaerobic digestion of biosolids are described. In an embodiment, a method for enhancing anaerobic digestion of biosolids may include measuring an alkalinity to volatile acid ratio of a bulk of biosolids. The method may further include adding a magnesium compound to the bulk of biosolids to achieve an alkalinity to volatile acid ratio of greater than about 10.

### CROSS-REFERENCE TO RELATED APPLICATIONS

This application claims the benefit of U.S. provisional patent application Ser. No. 62/403,926, filed on Oct. 4, 2016, entitled Anaerobic Digester Enhancement, the entire disclosure of which is incorporated herein by reference.

### TECHNICAL FIELD

The present disclosure is generally directed to the treatment of biosolids, and more particularly directed to enhancing anaerobic digestion processes for biosolids.

### BACKGROUND

Many wastewater treatment systems, such as municipal and/or commercial wastewater treatment systems, may often accumulate biosolids. In general, biosolids may include organic material that may be extracted from the wastewater as part of the treatment process. In many cases, the biosolids may be accumulated, or extracted, in the form of sludges, or otherwise at least partially de-watered solid components of the wastewater being treated. Ultimately, the biosolids must be removed from the wastewater treatment system and disposed of.

### SUMMARY

According to an implementation, a method may include measuring an alkalinity to volatile acid ratio of a bulk of biosolids. The method may further include adding a magnesium compound to the bulk of biosolids to achieve an alkalinity to volatile acid ratio of greater than about 10.

One or more of the following features may be included. The bulk of biosolids may include biosolids accumulated in a wastewater treatment system. The wastewater treatment system may include a municipal wastewater treatment system. The bulk of biosolids may include biosolids accumulated within an anaerobic digester system of the wastewater treatment system. The magnesium compound may be added to the bulk of biosolids within the anaerobic digester system of the wastewater treatment system. Adding the magnesium compound to the bulk of biosolids may include adding the magnesium compound to the wastewater treatment system upstream of the anaerobic digester system.

The bulk of biosolids may include biosolids extracted from a wastewater treatment system for transportation. Adding the magnesium compound to the bulk of biosolids may include adding the magnesium compound to the bulk of biosolids prior to extraction from the wastewater treatment system. Adding the magnesium compound to the bulk of biosolids may include adding the magnesium compound to the bulk of biosolids after extraction from the wastewater treatment system.

The magnesium compound may include one or more of magnesium oxide and magnesium hydroxide. The magnesium compound may include magnesium hydroxide exhibiting an alkaline magnesium hydroxide purity of between about 85% to about 100%. The magnesium compound may include magnesium hydroxide exhibiting a caustic magnesia activity of between about 50 seconds to about 1440 minutes. The magnesium compound may exhibit a particle size of between about 01. Micron to about 50 microns, and a specific surface area of between about 9 m²/g to about 200 m²/g.

Adding the magnesium compound to the bulk of biosolids may include adding the magnesium compound to achieve an alkalinity to volatile acid ratio of greater than about 15. Adding the magnesium compound may include maintaining a pH within the mass of biosolids less than about 9.

The method may further include adding one or more iron salts to the mass of biosolids. The one or more iron salts may include one or more of ferrous chloride, ferric chloride, ferrous sulfate, ferric sulfate, and combinations thereof. The method may further include adding one or more of an organic acid, a biological catalyst, an enzyme, a polymer salt, an inorganic salt, and combinations thereof to the mass of biosolids.

According to another implementation, a method may include measuring an alkalinity to volatile acid ratio of a bulk of biosolids. The method may also include adding a magnesium compound to the bulk of biosolids. The method may also include adding an iron salt to the bulk of biosolids. The method may further include adjusting a concentration of the magnesium compound added to the bulk of biosolids to achieve an alkalinity to volatile acid ratio of greater than about 15.

One or more of the following features may be included. Adding the magnesium compound to the bulk of biosolids may include adding the magnesium compound to an anaerobic digester system of a municipal wastewater treatment system. Adding the magnesium compound to the bulk of biosolids may include adding the magnesium compound to a municipal wastewater treatment upstream of an anaerobic digester system of the municipal wastewater treatment system.

### DESCRIPTION OF EXAMPLE EMBODIMENTS

According to some embodiments consistent with the present disclosure, biosolids may be treated through a process of anaerobic digestion. Anaerobic digestion of biosolids may, in some implementations, consume at least some of the organic materials in the biosolids and/or otherwise stabilize the biosolids and render the resultant solids suitable for more ecologically conscientious disposal and/or reuse, such as in agricultural land applications. Further in some implementations, the anaerobic digestion of biosolids may allow for the production of methane, e.g., as a by-product of the anaerobic biological activity of the anaerobic digestion process. In some such implementations, at least a portion of the methane may be recovered, and may be used as a fuel source. Consistent with some embodiments, the present disclosure may allow for more effective anaerobic digestion of biosolids, for example, by permitting a greater quantity of biosolids or organic feedstock, by permitting more rapid and/or more complete anaerobic digestion of biosolids, and/or by preferentially supporting certain anaerobic digestion processes and/or mechanisms to enhance desired by-products, such as methane and/or agriculturally useful nutrients.

Consistent with the foregoing, in some embodiments, methods for enhancing anaerobic digestion of biosolids may be provided. In an illustrative example embodiment, a method for enhancing anaerobic digestion of biosolids may include measuring an alkalinity to volatile acid ratio of a bulk of biosolids. The method may further include adding a magnesium compound to the bulk of biosolids to achieve an alkalinity to volatile acid ratio of greater than about 10. As generally used herein, a bulk of biosolids may include any suitable biosolids supply stream and/or accumulation. Further, in some embodiments a bulk of biosolids may include an aqueous medium of water which contains soluble constituents and suspended solid constituents, which may include inorganic, organic and/or biological components. Consistent with some implementations, the present disclosure may allow for optimizing one or more of the volatile acid to alkalinity ratio, pH, and/or other operational parameters of anaerobic digestion through the use of magnesia alone or in combination with one or more iron salts in order to achieve increased Volatile Solids Reduction (VSR) and/or increased Specific Yield (SY) of methane production, e.g., which may often be measured as cubic feet of methane per pound of volatile solids consumed. Accordingly, consistent with some embodiments of the present disclosure, it may be possible to increase the organic carbon loading (e.g., organic food sources) within an anaerobic digester and/or anaerobic digestion process, to generate a greater amount of total methane through the addition of magnesium compounds, alone and/or in combination with one or more iron salts.

As is generally understood, wastewater treatment may include, a variety of processes, which may remove, or at least reduce the amount of, undesirable constituents from the wastewater being treated so that the resultant treated water may be returned to the environment and/or otherwise put to further use. Typically, wastewater treatment may include, at least in part, the separation of organic material, including solids from the wastewater being treated. Often, the solids may be extracted and dewatered resulting in a sludge of high-strength organic wastes, which may include a relatively high concentration of solids, such as organic materials. Consistent with the present disclosure, a wastewater treatment system may include an anaerobic digestion system as part of the treatment of organic wastes. In some implementations, the organic wastes may be separated into a bulk of biosolids. As used herein, a bulk of biosolids may include any accumulation or containment of biosolids which may be generally separated from the wastewater being treated and/or separated from the treated wastewater. In some implementations, the bulk of biosolids may be maintained in an anaerobic digester (e.g., a containment area or vessel for facilitating anaerobic digestion of the biosolids) in a treatment plant, or elsewhere (e.g., where extracted biosolids may be stored or accumulated for later disposal, or the like). In some implementations, anaerobic digestion may serve to consume organics, stabilize the biosolids, and/or render the resultant solids suitable for disposal or reuse, such as agricultural land application. Additionally, in some implementations, anaerobic digestion may produce methane as a by-product of anaerobic biological activity. In some embodiments, at least a portion of the methane may be recovered as a fuel source.

Continuing with the foregoing, consistent with some embodiments, the bulk of biosolids may include biosolids that may be accumulated in a wastewater treatment system. Examples of wastewater treatment systems may include, but are not limited to, municipal, commercial, and/or industrial wastewater treatment systems. In some particular illustrative embodiments, the bulk of biosolids may include biosolids accumulated within an anaerobic digester system of the wastewater treatment system.

Consistent with some embodiments, magnesium compounds may be added to the bulk of biosolids to facilitate and/or enhance certain mechanisms of anaerobic digestion of the bulk of biosolids. For example, characteristic of most anaerobic digestion, there may be two general classifications of microorganisms that take part in the biological breakdown of organic food sources and conversion to methane. One classification of microorganisms may include acid formers (e.g., acidogens, acetogens). A second classification of microorganisms may include methane formers (e.g., methanogens). In the interest of increasing the production of methane, it may be desirable to add more organic materials (e.g., greater quantities of biosolids and/or biosolids including a higher concentration of organic materials). However, consistent with conventional techniques of anaerobic digestion, the addition of more organic material to the anaerobic digester may result in an increased production of acids (e.g., organic acids and/or inorganic acids) and acid forming microorganisms. The increased acids in the bulk of biosolids may adversely affect performance of the methanogens, e.g., and thereby reduce the production of methane from bulk of biosolids. Consistent with the present disclosure, magnesium compounds may be added to the bulk of biosolids to overcome, and/or at least partially mitigate, the alkalinity limited reactions (e.g., the accumulation of acids within the bulk of biosolids. Consistent with some embodiments of the present disclosure, the addition of magnesium compounds may increase the available pH buffering, which may prevent, and/or decrease, the reduction in pH of the bulk of biosolids (e.g., as a result of the acids produced by the acid forming microorganisms. By increasing the pH buffering (e.g., and thereby decreasing the reduction of pH) methanogen activity may be less inhibited by the acids produced by the acid forming microorganisms.

Furthermore, in some situations, increasing the amount and/or concentration of organic materials in the bulk of biosolids may additionally increase nutrient (e.g., phosphorus as phosphate and/or nitrogen as ammonia) loading within the anaerobic digester. Such an increase in nutrient loading within the anaerobic digester may lead to formation of scale within the digesters. Further, an increase in nutrient loading within the anaerobic digester may result in toxicity issues. Further, increasing the amount and/or concentration of organic materials in the bulk of biosolids may increase H₂S gas production in methane recovery systems. The increased H₂S gas production may result in, and/or increase the likelihood of, digester toxicity, nuisance odors, hazardous working conditions and corrosion of methane driven engines and turbines.

Consistent with the foregoing, in some embodiments, more organics (e.g., a greater quantity of biosolids and/or a greater concentration of organic material within the biosolids) may be added to the anaerobic digestion, while still providing a desirable and/or increased level of methane production. For example, the additional of magnesium compounds to the bulk of biosolids may increase the available pH buffering within the bulk of biosolids, e.g., which may allow the amount and/or concentration of organics in the bulk of biosolids undergoing anaerobic digestion to be increase while reducing, and/or eliminating, the acid limiting impact of the acid forming microorganisms on the methanogens. Further, in some embodiments, the addition of magnesium compound alone, or in combination with Fe-iron salts, to the bulk of biosolids undergoing anaerobic digestion may reduce the occurrence of scale and toxicity that may result from increased nutrient loading. In some embodiments, the addition of magnesium compounds alone, or in combination with Fe-iron salts, to the bulk of biosolids may inhibit the production of H₂S gas, e.g., which may reduce the likelihood of digester toxicity, nuisance odors, hazardous working conditions and/or corrosion of methane driven engines and turbines.

Consistent with embodiments of the present disclosure, an alkalinity to volatile acid ratio of the bulk of biosolids may be measured. The measure of alkalinity to volatile acid ratio may quantify the amount of alkalinity within the bulk of biosolids relative to the amount of volatile acids present in the bulk of biosolids. Consistent with the present disclosure, sufficient magnesium compounds may be added to the bulk of biosolids to maintain sufficient biological function and operation within the anaerobic digester relative to the amount of volatile acids accumulating in the bulk of biosolids (e.g., as a result of anaerobic digestion of organic material within the bulk of biosolids by acid forming microorganisms). Conventional anaerobic digestion systems may maintain an alkalinity to volatile acid ratio of less than about 10. Consistent with embodiments of the present disclosure, magnesium compounds may be added to the bulk of biosolids to achieve an alkalinity to volatile acid ratio of greater than about 10. Accordingly, the addition of the magnesium compounds may provide sufficient alkalinity buffering to reduce the acid limiting impact of the acid forming microorganisms on methane production by the methanogens. In some implementations, adding the magnesium compounds to the bulk of biosolids to achieve an alkalinity to volatile acid ratio of greater than about 10 may include adding a calculated quantity of magnesium compounds to the bulk of biosolids based upon, at least in part, a measured and/or estimated quantity of organic materials within the bulk of biosolids. In some implementations, adding magnesium compounds to the bulk of biosolids to achieve an alkalinity to volatile acid ratio greater than about 10 may include performing one or more measurements of alkalinity to volatile acid ratio of the bulk of biosolids and adjusting the magnesium compound concentration (e.g., the amount of added magnesium compounds) to achieve the desired alkalinity to volatile acid ratio.

In an embodiment, the magnesium compound may include one or more of magnesium oxide and magnesium hydroxide. For example, the magnesium compound may include only magnesium hydroxide. In some examples, the magnesium compound may include only magnesium oxide. In some embodiments, the magnesium compound may include various combinations of both magnesium hydroxide and magnesium oxide. Consistent with the present disclosure, various grades of magnesium compound may be utilized.

In some embodiments, the quality and reactivity of magnesium compound may be selected to provide desirable performance. In some situations, a relatively less reactive grade of magnesia, such as Brucite, may not provide sufficient alkalinity buffering, e.g., as might be achieved with relatively more reactive grades of magnesia. Illustrative examples of relatively more reactive magnesium compound may include Thioguard® and Magox® brands of magnesium hydroxide and magnesium oxide available from Premier Magnesia, LLC. However, in some implementations less reactive grades of magnesia may be acceptably utilized to varying degrees of efficacy. In some implementations, relatively less reactive grades of magnesium compounds may be used in conjunction with relatively higher reactivity grades of magnesium compounds to achieve a specific result.

In an example embodiment, magnesium compounds (e.g., magnesium oxide and/or magnesium hydroxide) may be utilized having a relatively high degree of purity. In an example embodiment, magnesium compounds may be provided having an alkaline magnesium oxide and/or alkaline magnesium hydroxide purity of between about 85% to about 100% pure alkaline magnesium oxide and/or magnesium hydroxide. In an illustrative embodiment, a magnesium compound may be provided having an alkaline magnesium oxide and/or alkaline magnesium hydroxide purity of between about 91% to about 98% pure alkaline magnesium oxide and/or magnesium hydroxide.

In some embodiments, a magnesium compound may include magnesium hydroxide exhibiting a caustic magnesia activity (“CMA”) neutralization time of between about 50 seconds to about 1440 minutes using 1.0N acetic acid and a magnesium hydroxide content of between about 10% to about 100%. In some embodiments, a magnesium compound may include magnesium oxide exhibiting a caustic magnesia activity neutralization time of between about 30 seconds to about 3600 seconds using 1.0N acetic acid and a magnesium oxide content of between about 10% to about 100%. In some embodiments, a magnesium compound may include magnesium oxide exhibiting a caustic magnesia activity neutralization time of between about 50 seconds to about 1000 seconds using 1.0N acetic acid and a magnesium oxide content of between about 10% to about 100%. In an embodiment, the magnesium compound may be provided exhibiting a caustic magnesia activity neutralization time of between about 50 seconds to about 200 seconds using a 1.0N acetic acid and a magnesium oxide and/or magnesium hydroxide content of between about 10% to about 100%. In a particular example embodiment, the magnesium compound may be provided exhibiting a caustic magnesia activity neutralization time of about 125 seconds using a 1.0N acetic acid and a magnesium oxide and/or magnesium hydroxide content of between about 10% to about 100%.

In an embodiment, the magnesium compound may be provided having a particle size that may provide an enhanced specific surface area (“SSA”). For example, generally, a magnesium compound having a smaller particle size may enhance the overall specific surface area of the magnesium compound (e.g., which may include magnesium oxide and/or magnesium hydroxide). In an embodiment, a magnesium compound may include a magnesium hydroxide exhibiting a particle size of between about 0.1 micron to about 50 micron. In some embodiments, a magnesium compound may include magnesium oxide exhibiting a particle size of between about 0.1 micron to about 30 micron. For example, in an embodiment, the magnesium compound may include a magnesium oxide and/or magnesium hydroxide having a particle size of between about 1 micron to about 20 microns. In one illustrative embodiment, the magnesium compound may include a magnesium oxide and/or magnesium hydroxide having an average particle size of about 10 micron.

In an embodiment, a magnesium compound may be provided having a desired reactivity. A magnesium compound having a relatively higher reactivity may provide more complete and efficient use within a desired application, and may, in some instances, at least partially offset a relatively low solubility that may be associated with magnesium compounds such as magnesium oxide and/or magnesium hydroxide. In an embodiment, specific surface area (“SSA”) of the magnesium compound may be correlated to reactivity, e.g., in which a relatively higher specific surface area may be correlated to a relatively higher reactivity. In some embodiments, a magnesium compound may include magnesium hydroxide exhibiting a specific surface area of between about 9 m²/g to about 200 m²/g. For example, in an example embodiment, a magnesium compound may include magnesium hydroxide having a specific surface area in the range of between about 9 m²/gram to about 50 m²/gram. In one particular embodiment, a magnesium hydroxide may include a specific surface area of about 12 m²/gram. In some embodiments, a magnesium compound may include magnesium oxide exhibiting a specific surface area of between about 9 m²/g to about 300 m²/g, or greater. For example, in an example embodiment, a magnesium compound may include magnesium oxide having a specific surface area in the range of between about 9 m²/gram to about 150 m²/gram, or greater.

While magnesium compounds having various different characteristics (such as purity, CMA, particle size, and SSA) have been described, it will be understood that such characteristics, and representative values, are provided for the purpose of illustration and example. Consistent with the present disclosure, magnesium oxide and/or magnesium hydroxide compounds having different characteristic values may be utilized in connection with treating biosolids to varying degrees of efficacy, either individually or in combination.

In some embodiments, combinations of magnesium compounds having different reactivities may be utilized in connection with the enhancement of anaerobic digestion of biosolids. For example, in an embodiment relatively high reactivity magnesium compounds and relatively lower reactivity magnesium compounds may be used together to achieve a particular effect relative to the anaerobic digestion of biosolids. In some embodiments, the combination of magnesium compounds having different reactivities may achieve synergistic benefits. For example, combinations of magnesium compounds having differing reactivities may be added to the bulk of biosolids. In some such embodiments, the different magnesium compounds having different reactivities may provide a synergistic result, for example, in terms of promoting certain reactions and/or digestive mechanisms.

In an embodiment, the magnesium compound may be added to the bulk of biosolids within the anaerobic digester system of the wastewater treatment system. For example, as generally described above, a wastewater treatment system, such as a municipal or other wastewater treatment facility, may include a variety of systems, or processes, for the treatment of the wastewater received from domestic, commercial and/or industrial sources. Such systems or process may include, but are not limited to, filtration and separation processes, e.g., which may remove solid and organic materials from the wastewater being treated. One such system in the wastewater treatment system may include an anaerobic digester system, by which the biosolids extracted from the wastewater may undergo anaerobic processing, as generally described above. In an embodiment, the magnesium compound may be added to the anaerobic digester system of the wastewater treatment system, e.g., which may include one or more containment tanks, vessels, or the like.

In some embodiments, adding the magnesium compound to the bulk of biosolids may include adding the magnesium compound to the wastewater treatment system upstream of the anaerobic digester system. For example, adding the magnesium compound upstream in wastewater treatment system relative to an anaerobic digester system of the wastewater treatment system may facilitate distribution and/or mixing of the magnesium compounds throughout the anaerobic digester system. In an embodiment, the magnesium compound may be added at an inlet of the anaerobic digester system and/or in a transport pipe feeding the anaerobic digester system.

In one embodiment, adding the magnesium compound to the anaerobic digester system (e.g., either directly to the anaerobic digester system and/or upstream of the anaerobic digester system) may increase alkalinity in the anaerobic digester system. In some embodiments, as generally described above, the magnesium compound may be added in a quantity and/or concentration (i.e., the dosing of the magnesium compound) to achieve a ratio of alkalinity to volatile acids (Alk/VA ratio) above the conventional normal operating Alk/VA of less than about 10. Consistent with some embodiments, the magnesium compound may be added to achieve an Alk/VA of greater than 10. In some embodiments, the magnesium compound may be added to achieve an Alk/VA level equal to, or greater than, about 15, which is typically considered outside normal operating conditions. The effect of modifying the Alk/VA to this range may be to allow for an increased yield (cubic feet of methane or digester gas per pound of volatile solids destroyed) and/or to allow for more total organics to be loaded to the digester to produce more gas. The beneficial addition of the magnesium compound to achieve the above described alkalinity to volatile acid ratio may prevent and/or reduce the occurrence of acid limiting conditions on the methane production and/or to prevent and/or reduce the occurrence of toxicity within the anaerobic digester (i.e., within the bulk of biosolids undergoing anaerobic digestion).

In some implementations, it has been recognized that the magnesium compound dosing maximum may be limited by the bulk pH of the digester mixed liquor. For example, the dosing of magnesium compound may be adjusted based on maximizing the alkalinity of the bulk of biosolids undergoing anaerobic digestion (or to undergo anaerobic digestion in the future), while keeping the pH of the bulk of biosolids below about 9. In some embodiments, the dosing of the magnesium compound may be adjusted based on maximizing the alkalinity of the bulk of biosolids while maintaining the pH of the bulk of biosolids between a pH of about 7 to about 8. Consistent with some embodiments, the ratio of alkalinity to volatile acids may be any value in excess of approximately 15, and may only be limited on the upper end by the quantity of magnesium compound that causes pH to rise above about 9.

Continuing with the foregoing, collectively, the operation of anaerobic digestion may be limited by hydraulics (e.g., when influent and effluent flow rates exceed microorganism growth rates, a depletion of working biota in the digester may occur), pH or Alkalinity (e.g., at which acid production rate may consume alkalinity at a rate sufficient to suppress pH and inhibit biology), toxicity (e.g., constituents may accumulate in the bulk of biosolids undergoing anaerobic digestion at a rate that may negatively affect the biology of the microorganisms). In consideration of the foregoing, in some implementations, the higher the ratio of alkalinity to volatile acids, the higher the capacity of the anaerobic digester system to receive organics, but may be limited both by the upper pH limit and hydraulics of the system. That is, in an embodiment, the ratio of alkalinity to volatile acids may be achieved that may approach the upper operational limits of the digester (e.g., above which operational limits of the performance of the digester may be deleteriously impacted). Alk/VA ratios below 10 are typically considered conventional norms because of the economic cost associated with achieving and maintaining higher ratios may be untenable. In conventional systems, alkalinity may be viewed as a process limiting reagent, and may be provided only at a level necessary to accommodate relatively modest organic loadings. Additionally, when using conventional alkalinity modifying agents, such as caustic soda or lime, such Alk/VA ratios consistent with the present disclosure may not be readily obtainable without adversely affecting the pH of the system.

In addition and/or as an alternative to adding magnesium compound to an anaerobic digester system, the magnesium compound may be added to the bulk of biosolids prior to extraction from the wastewater treatment system, including prior to the bulk of biosolids being processed by an anaerobic digester system. For example, the solids and organic materials may be filtered, settled and/or otherwise separated from the wastewater being treated by a wastewater treatment system, e.g., for processing in an anaerobic digester that may not be included as part of the wastewater treatment system, and/or for processing in an anaerobic digester that is not directly part of the wastewater treatment flow (e.g., the biosolids may not flow directly from a filtration and/or separation system to an anaerobic digester). In such an embodiment, the magnesium compound may be added to the biosolids within a filtration and/or separation system of the wastewater treatment system. The bulk of biosolids (e.g., with the added magnesium compound) may subsequently be extracted from the wastewater treatment system (e.g., from a filtration and/or separation system of the wastewater treatment system), for example, for later processing in an anaerobic digester, either associated with the wastewater treatment system and/or separate from the wastewater treatment system. Further, in some embodiments, the magnesium compound may be added to the bulk of biosolids after the bulk of biosolids has been extracted from the wastewater treatment system (e.g., after extraction from a filtration and/or separation system of the wastewater treatment system). In one particular example, an anaerobic digester may be physically separate from the wastewater treatment system, and/or from a filtration and/or separation system of the wastewater treatment system through which the bulk of biosolids may be extracted from the wastewater being treated. In one such embodiment, the magnesium compound may be added to a bulk of biosolids extracted from a wastewater treatment system for transportation to an anaerobic digester.

Consistent with the foregoing, in an embodiment, the magnesium compound may be added to the organic waste (e.g., bulk of biosolids) in storage prior to addition of the bulk of biosolids to an anaerobic digester. In such an embodiment, biological activity occurring within the organic waste while in storage (e.g., prior to addition to the anaerobic digester) may generate gases that may be malodorous and/or increase pressure within an unventilated storage vessel. The biological activity may also modify the organic waste in an undesirable manner. Consistent with some embodiments of the present disclosure, in such a situation, magnesium compounds may be added to the bulk of biosolids to reduce the total gases, malodorous or otherwise, that may cause odor or pressure issues in the storage vessels. Magnesium compounds may also be added to the bulk of biosolids to reduce the biological activity of microorganisms that may produce gases by shifting the pH away from the optimal range for biological activity of such microorganisms. The dosing of the magnesium compounds to the storage vessel may be based upon, at least in part, the need to reduce gases, biological activity, and/or the operational conditions of the anaerobic digester(s) to which the organic wastes are to be added.

In another embodiment, an anaerobic digester may be physically separated (e.g., including significantly geographically separated) from the wastewater treatment system (e.g., a filtration and/or separation system of the wastewater treatment system) from which the bulk of biosolids are extracted. In one such embodiment, magnesium compounds may be added to the organic waste (e.g., bulk of biosolids) prior to loading and transportation via a container, a bulk hauling truck, a railcar, or any other method of contained transportation. Similar to the above described embodiment, ongoing biological activity within the organic waste in a transportation container or vessel may create gases that can build pressure or cause odors. Through biological activity, the organic waste in the transportation vessel may generate gases that may be malodorous and/or increase pressure of an unventilated vessel. The biological activity may also modify the organic waste in an undesirable manner. In some embodiments consistent with the foregoing situation, magnesium compounds may be added to the bulk of biosolids prior to loading into a transportation container or vessel to reduce the total gases, malodorous or otherwise, that may cause odor or pressure issues in the transportation vessels. Magnesium compounds may also be added to the bulk of biosolids to reduce the biological activity of microorganisms that produce gases by shifting the pH away from their optimal range. The dosing of magnesium compounds to the transportation vessel may be based in part on the need to reduce gases, biological activity or the operational conditions of the anaerobic digester(s) to which the organic wastes are to be added. For example, in some situations, as a by-product of biological activity, carbon dioxide CO₂ may make up a significant fraction of the gases produced by biologically affected organics. The addition of the magnesium compound may be added to reduce biological activity producing carbon dioxide, and/or by keeping acid gases like H₂S or CO₂ in solution, and thus reducing impacts on system pressure.

In some embodiments, the magnesium compounds may be used alone. In other embodiments, the magnesium compounds may be added to the bulk of biosolids in combination with one or more other agents. For example, in some embodiments, one or more iron salts may be added to the mass of biosolids. For example, the one or more iron salts may include one or more of ferrous chloride, ferric chloride, ferrous sulfate, ferric sulfate, and combinations thereof. Further, one or more of an organic acid, a biological catalyst, an enzyme, a polymer salt, an inorganic sate, and combinations thereof may be added to the mass of biosolids. As generally discussed above, in some implementations, the addition of the magnesium compounds may raise the pH of the anaerobic digester to a level that may inhibit methane production and/or may otherwise inhibit desired biological activity. In some embodiments, iron salts may be added to the bulk of biosolids to control the rise in pH resulting from the addition of the magnesium compounds. As such, the pH of the bulk of biosolids may be maintained within an acceptable range, even with the addition of the magnesium compounds. As also discussed above, as organic loading to the anaerobic digester increases (e.g., manifesting by an increased bulk of biosolids and/or organic content or concentration within the bulk of biosolids), phosphate production and/or concentration within the bulk of biosolids may increase, and/or H₂S gas production may increase, which may inhibit methane production and/or may inhibit desired biological activity, or otherwise result in undesirable outcomes. In some embodiments, the combination of iron salts with the magnesium compounds may mitigate the increased phosphate production and/or concentration within the bulk of biosolids and/or may reduce the production and/or release of H₂S gas from the bulk of biosolids.

For example, in an embodiment, the magnesium compound may be added to the bulk of biosolids along with a ferrous salt, a ferric salt, or some combination of both. These ferrous or ferric salts may include but are not limited to: ferrous chloride, ferric chloride, ferrous sulfate, ferric sulfate or some combination thereof. In some example embodiments, the ferrous and/or ferric salt may be added to facilitate H₂S control, phosphate control, and/or to control other products of biological activity within the bulk of biosolids (e.g., either during anaerobic digestion, and/or during storage prior to anaerobic digestion). In some embodiments, the addition of ferrous salts and/or ferric salts may have the added effect of reducing alkalinity proportionally to the quantity added and possibly depressing pH. For example, the iron salts may generally reduce H₂S gas emissions (e.g., by binding with sulfides and/or via other mechanisms) and may reduce phosphorus toxicity (e.g., phosphorous that may accumulate at increased rates due to the increase organic loading of the system). However, as noted above, in some situations, the addition of the iron salts may tend to deplete alkalinity and depress pH of the system. The dosing of the magnesium compound may be calculated based upon, at least in part, on the quantity of anticipated alkalinity depleted by the iron salts and by the quantity necessary to improve the working capacity and output of the anaerobic digester. That is, for example, the dosing of the magnesium compound may, at least in part, be implemented to counter the acid effects of the added iron, while enhancing and/or maintaining the working pH and alkalinity profile of the anaerobic digester, consistent with the foregoing discussion.

In a similar manner as previously described, in an embodiment, the magnesium compound may be added in conjunction with a ferrous salt, a ferric salt, or some combination of both, to the organic waste (e.g., the bulk of biosolids) in storage prior to addition to an anaerobic digester. Through biological activity, the organic waste in storage prior to being added to the anaerobic digester may generate gases that may be malodorous and/or increase pressure of an unventilated vessel. The biological activity may also modify the organic waste in an undesirable manner. The combination of the magnesium compound and the iron salt may reduce the total gases, malodorous or otherwise, that may cause odor or pressure issues in the storage vessels. In some embodiments, the combination of the magnesium compound and the iron salt may also reduce the biological activity of microorganisms that may produce gases by shifting the pH away from the optimal range for biological activity of such microorganisms. The dosing of the magnesium compound and the iron salt to the storage vessel may be based upon, at least in part, the need to reduce gases, biological activity, phosphate, sulfides or the operational conditions of the anaerobic digester(s) to which the organic wastes are to be added.

In another embodiment, magnesium compounds may be added in conjunction with a ferrous salt, a ferric salt, or some combination of both to the organic waste (e.g., the bulk of biosolids) prior to loading and transportation via container, bulk hauling truck or railcar, or any other method of contained transportation, where ongoing biological activity within the organic waste may create gases that can build pressure or cause odors. Through biological activity, the organic waste in the transportation vessel may generate gases that may be malodorous and/or increase pressure of an unventilated vessel. In some situations, the biological activity may also modify the organic waste in an undesirable manner. The combination of the magnesium compound and iron salts may be used to reduce the total gases, malodorous or otherwise, that may cause odor or pressure issues in the transportation vessels. The combination of magnesium compounds and iron salts may also reduce the biological activity of microorganisms that produce gases by shifting the pH away from the optimal range for biological activity of such microorganisms. The dosing of the magnesium compound and the iron salts to the transportation vessel may be based upon, at least in part, the need to reduce gases, biological activity, or the operational conditions of the anaerobic digester(s) to which the organic wastes are to be added.

Consistent with embodiments of the present disclosure, it has been recognized that, for example, within the context of cities, utilities and/or industry, there is a growing interest in diverting organics that would be sent to landfills or otherwise disposed of, and instead processing the organic via anaerobic digesters for the purposes of recovering energy (methane) and nutrients (phosphorus and nitrogen). Accordingly, the present disclosure may provide for methods and compositions to increase the working capacity of digesters in terms of total organic and hydraulic inputs that may be implemented to allow for much greater recovery of energy and nutrients than has conventionally been possible. As described above, methods consistent with the present disclosure may include using magnesia (e.g., magnesium oxide, magnesium hydroxide, and/or some combination thereof) alone or in combination with an iron salt (e.g., ferrous salts, ferric salts, and/or some combination) and/or another additive agents (e.g., organic acids, biological catalysts, enzymes, polymer or inorganic salt, and the like) in order to increase the capacity and yield of an anaerobic digester.

A number of implementations have been described. Nevertheless, it will be understood that various modifications may be made. Accordingly, other implementations are within the scope of the following claims.

What is claimed is:

1. A method comprising:
measuring an alkalinity to volatile acid ratio of a bulk of biosolids; and
adding a magnesium compound to the bulk of biosolids to achieve an alkalinity to volatile acid ratio of greater than about 10.

2. The method of claim 1, wherein the bulk of biosolids includes biosolids accumulated in a wastewater treatment system.

3. The method of claim 2, wherein the wastewater treatment system includes a municipal wastewater treatment system.

4. The method of claim 2, wherein the bulk of biosolids include biosolids accumulated within an anaerobic digester system of the wastewater treatment system.

5. The method of claim 4, wherein the magnesium compound is added to the bulk of biosolids within the anaerobic digester system of the wastewater treatment system.

6. The method of claim 4, wherein adding the magnesium compound to the bulk of biosolids includes adding the magnesium compound to the wastewater treatment system upstream of the anaerobic digester system.

7. The method of claim 1, wherein the bulk of biosolids include biosolids extracted from a wastewater treatment system for transportation.

8. The method of claim 7, wherein adding the magnesium compound to the bulk of biosolids includes adding the magnesium compound to the bulk of biosolids prior to extraction from the wastewater treatment system.

9. The method of claim 7, wherein adding the magnesium compound to the bulk of biosolids includes adding the magnesium compound to the bulk of biosolids after extraction from the wastewater treatment system.

10. The method of claim 1, wherein the magnesium compound includes one or more of magnesium oxide and magnesium hydroxide.

11. The method of claim 1, wherein the magnesium compound includes magnesium hydroxide exhibiting an alkaline magnesium hydroxide purity of between about 85% to about 100%; a caustic magnesia activity of between about 50 seconds to about 1440 minutes.

12. The method of claim 1, wherein the magnesium compound exhibits a particle size of between about 01. Micron to about 50 microns, and a specific surface area of between about 9 m2/g to about 200 m2/g.

13. The method of claim 1, wherein adding the magnesium compound to the bulk of biosolids includes adding the magnesium compound to achieve an alkalinity to volatile acid ratio of greater than about 15.

14. The method of claim 1, wherein adding the magnesium compound includes maintaining a pH within the mass of biosolids less than about 9.

15. The method of claim 1, further comprising adding one or more iron salts to the mass of biosolids.

16. The method of claim 15, wherein the one or more iron salts include one or more of ferrous chloride, ferric chloride, ferrous sulfate, ferric sulfate, and combinations thereof

17. The method of claim 1, further comprising adding one or more of an organic acid, a biological catalyst, an enzyme, a polymer salt, an inorganic salt, and combinations thereof to the mass of biosolids.

18. A method comprising:
measuring an alkalinity to volatile acid ratio of a bulk of biosolids;
adding a magnesium compound to the bulk of biosolids;
adding an iron salt to the bulk of biosolids; and
adjusting a concentration of the magnesium compound added to the bulk of biosolids to achieve an alkalinity to volatile acid ratio of greater than about 15.

19. The method of claim 18, wherein adding the magnesium compound to the bulk of biosolids includes adding the magnesium compound to an anaerobic digester system of a municipal wastewater treatment system.

20. The method of claim 18, wherein adding the magnesium compound to the bulk of biosolids includes adding the magnesium compound to a municipal wastewater treatment upstream of an anaerobic digester system of the municipal wastewater treatment system.
